(19) United States
(12) Patent Application Publication
(10) Pub. No.: US 2008/0153513 A1
(43) Pub. Date: Jun. 26, 2008

(54) MOBILE AD SELECTION AND FILTERING

(75) Inventors: Gary W. Flake, Bellevue, WA (US); Alexander G. Gounares, Kirkland, WA (US); Kamal Jain, Bellevue, WA (US); Lili Cheng, Bellevue, WA (US); David M. Chickering, Bellevue, WA (US); Christopher A. Meek, Kirkland, WA (US); Jeffrey R. Hemmen, Renton, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/767,360

(22) Filed: Jun. 22, 2007

Related U.S. Application Data
(60) Provisional application No. 60/870,926, filed on Dec. 20, 2006.

(51) Int. Cl. H04Q 7/20

(52) U.S. Cl. 455/456.3

(57) ABSTRACT

The claimed subject matter relates to an architecture that can filter or organize content such as advertisements that are either received by or transmitted to a mobile device. The filtering or organizing can be based upon local attributes associated with the mobile device (e.g., location, velocity, time, a profile), as well as based upon attributes associated with the advertiser (e.g., inventory, customer traffic). In addition, the architecture can provide for selection and/or display of advertisements based upon a bidding model, wherein advertisers can bid for mobile devices that exhibit certain characteristics.

### CROSS-REFERENCE TO RELATED APPLICATIONS

This application claims the benefit of U.S. Provisional Application Ser. No. 60/870,926, filed Dec. 20, 2006, entitled “ARCHITECTURES FOR SEARCH AND ADVERTISING.” The entirety of this application is incorporated herein by reference.

### BACKGROUND

With the meteoric rise of Internet users, advertisers are continually looking for new ways to reach these users with advertisements. Unfortunately, while it is very easy to deliver mass advertisements (e.g., SPAM) by way of Internet advertising, such advertisements are often not relevant to a user since the advertiser may have no information about the user other than an email address. Oftentimes, these advertisements are viewed as annoyances and commonly filtered by way of a SPAM filter mechanism. Advertisements that are tailored in some way for a user are generally less of an annoyance and may in fact be desired, however, tailoring an advertisement requires information associated with the user that is often difficult to obtain since most users are very weary about providing personal or private information to third parties.

In a similar domain, mobile device users have seen a more recent growth, for which advertisers are very keen to tap in suitable ways. For example, ads delivered to a mobile device can be effective in ways that conventional Internet-based ads are not. In particular, advertising is more effective when an ad consumer can act on the ad immediately. Thus, conventional Internet ads are typically limited to Internet-based purchases since most are received by email (when the Internet user is seated at a computer). However, ads delivered to a mobile device have the potential to be more applicable to brick-and-mortar products or services, as a user of the mobile device can be physically near retail or vendor outlets when the ad is received.

However, many of the difficulties associated with Internet advertising can exist in a mobile platform as well. To stem the potential for abuse or misuse of advertising SPAM, as was witnessed in the Internet domain, the mobile device platform has a need for a means or mechanism for organizing, categorizing, and/or filtering advertisements.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises an architecture that can facilitate an enhanced content (e.g., advertisement) organization for a mobile device. In accordance with another aspect of the claimed subject matter, the advertisements can be designed expressly for mobile devices and can be transmitted to mobile devices that are, e.g. presently at or in close proximity to a given location. These and other types of advertisements can be organized and/or filtered based upon a relevance, wherein the relevance can be determined or inferred based upon a wide variety of factors or attributes associated with the mobile device.

Such factors can include but are not limited to time, position, orientation, velocity, permissions or preferences, contractual obligations, as well as a mode or condition associated with the mobile device or a user of the mobile device. In addition, the architecture can select relevant advertisements for display, wherein the selection can be based upon similar factors or attributes as well as based upon a mobile device (or associated user) profile, or even based upon a bidding model. Hence, advertisers can bid on one or more of the attributes (or attribute values) such that ads can be tailored in specific ways that can be beneficial to all parties involved. For example, a gas station can bid for mobile devices that are traveling above a certain speed (indicative of travel by automobile), whereas an ice cream stand may bid for mobile devices traversing a course toward the stand and traveling below a certain speed (indicative of walking).

In accordance with another aspect of the claimed subject matter, the architecture (or portions thereof) can be components of the mobile device, whereas in other cases, the architecture (or portions thereof) can be remote from the mobile device. In the former case, ads can be delivered to the mobile device, where localized profile, attributes, and other data can be employed for the organization and selection of ads. Thus, personal or private information need not be shared with advertisers, yet the advertisements can still be organized, filtered, and/or selected in a manner consistent with ad targeting or customization. In the latter situation, advertisements can be organized and/or selected based upon aggregated inputs from mobile devices as well as based upon environmental variables associated with a particular store or location.

In either case, the architecture can also facilitate display of the advertisement. Generally, the advertisement is displayed on the mobile device, but in some cases, the advertisement can be displayed on other devices such as an electronic billboard that displays an advertisement based upon some information received from a nearby mobile device. According to another aspect, the architecture can organize the advertisement into an ad channel. Thus, the user of the mobile device need not be concerned about ads invading personal space, and in addition ads may be less stringently filtered to provide the user the ability to browse (or avoid) the ad channel at his or her own behest.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 is a block diagram of a system that can facilitate enhanced content organization for a mobile device.

FIG. 2 illustrates a block diagram of a system that can determine a relevance based upon a variety of factors.

FIG. 3 depicts a block diagram a system that can display an ad based upon advertiser bidding.

FIG. 4 illustrates a block diagram of a system that can display the advertisement to multiple devices.

FIG. 5 is a block diagram of a system that can facilitate tailored ad selection based upon attributes of a mobile device.

FIG. 6 illustrates a block diagram of a system that can utilize a bidding model for ad selection.

FIG. 7 is an exemplary flow chart of procedures that define a method for facilitating enhanced content organization for a mobile device.

FIG. 8 is an exemplary flow chart of procedures that define a method for determining a relevance.

FIG. 9 depicts an exemplary flow chart of procedures defining a method for providing additional features associated with ad organization.

FIG. 10 illustrates a block diagram of a computer operable to execute the disclosed architecture.

FIG. 11 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, or the like can refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

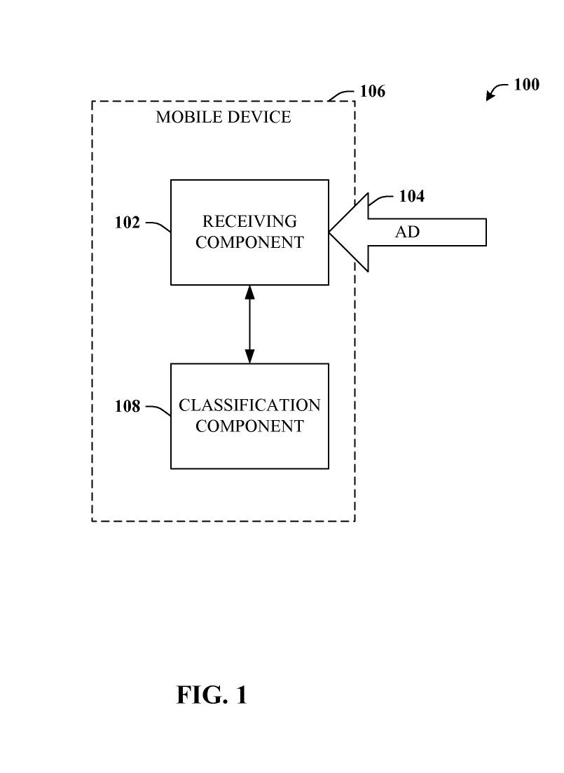

Referring now to the drawing, with reference initially to FIG. 1, a system 100 that can facilitate enhanced content organization for a mobile device, is depicted. Generally, the system 100 can include a receiving component 102 that can obtain an advertisement 104 delivered to a mobile device 106. The mobile device 106 is typically a cellular or smart phone, however, it is to be appreciated that the mobile device 106 can be substantially any portable electronic device such as laptops, tablets, media players/recorders, Personal Digital Assistants (PDAs), cameras, games, fobs, and so on. The mobile device 106 can be a handheld device as well as wearable device and generally includes suitable hardware for one or more types of wireless communication such as cellular, wireless fidelity (WiFi), Bluetooth, Near Field Communication (NFC), Radio Frequency Identification (RFID), etc.

In accordance with an aspect of the claimed subject matter, the advertisement 104 can be a mobile advertisement 104. As used herein, a mobile advertisement 104 can mean an advertisement that is specifically created or tailored for display on a mobile device 106. Furthermore, a mobile advertisement 104 can be an advertisement that is issued based upon a location, velocity, or path or trajectory of the mobile device 106.

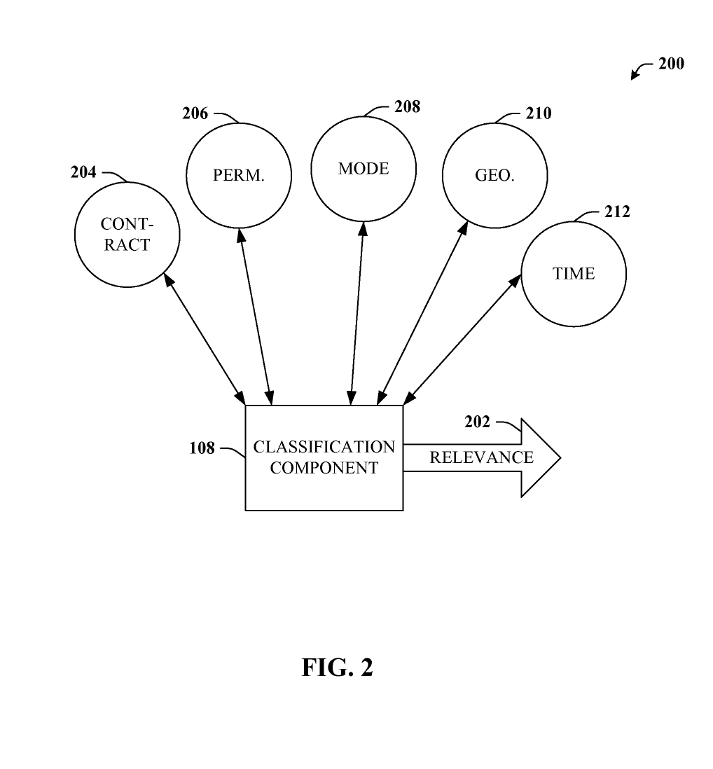

The system 100 can also include a classification component 108 that can organize the advertisement 104 based at least in part upon a relevance of the advertisement 104. The relevance can be defined as a determined or inferred importance, weight, or application to the mobile device 106 or a user of the mobile device 106 at the time the advertisement 104 is obtained or at a subsequent time, which is further detailed infra in connection with FIG. 2. However, it is to be appreciated that the classification component 108 can organize the advertisement 104 into a channel or folder based upon the relevance 202 as well as filter (and/or organize into a trash or SPAM folder) an advertisement 104 that has a low relevance 202. The classification component 108 can also organize the advertisement 104 appropriately to enable more rapid browsing, identification, and location of advertisement 104 as well as to prevent advertisement 104 from intermingling with personal or work-related content.

While still referring to FIG. 1, but turning also to FIG. 2, a system 200 that can determine the relevance 202 based upon a variety of factors is illustrated. The system 200 can include the classification component 108 as described herein. In accordance with an aspect of the claimed subject matter, the relevance 202 can be based upon a contractual obligation 204. For example, the mobile device 106 or service fees related thereto can be provided free of charge or an associated cost can be subsidized in exchange for rights or guarantees to deliver or display the advertisement 104 to the mobile device 106. Such contractual obligations 204 can affect the relevance 202 of the advertisement 104, and therefore how the advertisement 104 is organized by the classification component 108.

The relevance 202 can also be based upon permissions 206 associated with the mobile device 106. In turn the permissions 206 can be based upon default or user-defined mobile device 106 settings, as well as a wide range of other factor described herein. In accordance with another aspect, the classification component 108 can determine the relevance 202 based upon a mode 208. Typically, the mode 208 relates to a goal, intent, condition, or approach of a user of the mobile device 106. According to another aspect, the relevance 202 can be based upon geographic characteristics 210 such as a location of the mobile device 106 as well as a speed, a direction, or a route associated with the mobile device 106. Furthermore, the classification component 108 can determine the relevance 202 based upon a time 212. The time 212 can be associated with a time 212 in which the advertisement 104 is obtained, an amount of time (e.g., a “snooze” feature) subsequent to obtaining the advertisement 104, or a subsequent time 212 in which a set of conditions are satisfied.

In order to provide additional context, a number of examples and/or scenarios are provided below. It is to be appreciated that the scenarios and examples supplied herein are intended to be illustrative and are not necessarily intended to limit the scope of the appended claims to only the indicated examples or scenarios. As one example, consider a mobile device 106 carried by a user patronizing a shopping mall. Given the exposure to numerous products and services typically facilitated by a shopping mall, a variety of advertising opportunities can also be available. Moreover, the mobile device 106 can provide an excellent medium by which to solicit potential advertising opportunities for a number of reasons, many of which are discussed herein.

In accordance with the foregoing, an advertiser (e.g., a vendor within the mall or an entity or organization collectively representing the mall and/or one or more of the vendors) can subsidize the mobile device 106 (and/or associated service) in exchange for delivering advertising content when, say, the mobile device 106 is detected to be in close proximity to the mall. Thus, the classification component 108 can organize or filter an advertisement 104 based upon such contractual obligations 204. Additionally or alternatively, the classification component 108 can employ explicit permissions 206. For instance, instructions or preferences can be set to indicate that advertisements 104 are not desired or inappropriate unless certain thresholds, qualifications, or conditions are met. Thus, the classification component 108 can filter advertisement 104 unless they pertain to a particular product, service, vendor, advertiser, and so forth. Likewise, the classification component 108 can filter advertisements 104 unless they meet other permission 206 criteria such as providing a particular type of incentive (e.g., free trial, helpful data or information, more than, say, a 50% discount to a normal sale price, . . . ).

It is to be appreciated that all or portions of the relevance indicators 204-212 can be employed together, and, thus, the classification component 108 is not limited to utilizing only one type of relevance indicators 204-212 in order to determine the relevance 202 and/or to organize/filter the advertisement 104. For example, contractual obligations 204 can provide that at least some advertisements 104 must be accepted, but others can be filtered out based upon permissions 206 or the like. For instance, a user of the mobile device 106 might know exactly what goods or services will be purchased, and hence does not want to be inundated with advertisements that are likely to be irrelevant in that situation. However, the user may want a map of the mall, potentially marking a location where the desired product or service can be purchased. Therefore, advertisements 104 that include the map may be deemed to be relevant, whereas advertisements that do not might be filtered by the classification component 108.

In another aspect, the classification component 108 can filter or organize advertisements 104 based upon the mode 208. For example, the mobile device 106 (or user thereof) can be in a browsing mode 208 in which many types of advertisements 108 may be relevant, or in a purchase mode, where it is known exactly what will be purchased and/or where the product or service is located so it is conceivable that no advertisements are appropriate. In other aspects, the mode 208 can be based upon an ordering of events or transactions such that an advertisement 104 may only be relevant before or after a certain event or transaction. In another aspect, the mode 208 may relate to a condition of the mobile device 106 or user. For example, it can be detected if there is an error condition associated with the mobile device 106. Thus, an advertisement 104 relating to, say, a new battery or repair service may be deemed to be highly relevant in that case. Likewise, the mobile device 106 (or another device) may be equipped with sensors to detect conditions associated with the user, such as a blood sugar reading or the like, which in certain situations can make advertisements 104 relating to insulin management highly relevant.

According to an aspect of the claimed subject matter, the classification component 108 can organize or filter an advertisement 104 based upon geographic characteristics 210. Suitable geographic characteristics 210 can be a position or location of the mobile device 106. Thus, e.g. permissions 206 can be defined to indicate that the advertisement 104 is not desired unless the mobile device 106 is located in a suitable area, such as at the mall. Even without implementation of such permissions 206, the location or other geographic characteristic 210 can affect the relevance 202 of the advertisement 104.

Another type of geographic characteristic can be a velocity of the mobile device 106. For instance, knowledge that a mobile device 106 is in proximity to an outlet for an advertiser can make an associated advertisement 104 more relevant, however, the velocity can be useful as well. For example, if a mobile device 106 is traveling at 3 miles per hour, an advertisement 104 for a local coffee shop might be more relevant than an advertisement 104 for automobile fuel. Yet the reverse might be the case if the mobile device 106 is traveling at 30 miles per hour rather than 3 miles per hour. In addition, a direction or orientation can be employed to determine the relevance 202, as can a previous or an inference related to a projected course or route.

According to another aspect, the classification component 108 can employ time 212 to determine the relevance 202 of the advertisement 104. For example, the advertisement 104 may have relevant aspects based upon one or more of the relevance indicators 204-212 but an issue relating to time 212 may increase the relevance 202. As such, a snooze feature can be employed to organize the advertisement 104 for later use. Additionally or alternatively, input from a user of mobile device 106 can be employed as well such as input indicating that the advertisement 104 is appropriate or relevant, but just not at this time. In either case, display or some other further use of the advertisement 104 can be delayed for a certain amount of time or until certain conditions are satisfied.

One such condition can include a determination or inference for when the advertisement 104 should be displayed. Typically, advertisement 104 is usually more welcome (and therefore more effective) when a user of the mobile device 106 is not engaged in an important task or is otherwise inclined to devote some attention or focus to the advertisement 104 without delaying or unduly interfering with a current task. For example, while standing in a long line, advertisement 104 may be a welcome diversion, but perhaps less welcome at other times or less welcome while speaking to a client while standing in line. Accordingly, the classification component 108 can determine or infer a proper time 212 to display the advertisement 104 based upon relevance values associated with the advertisement 104.

In accordance with the foregoing it is to be appreciated that the classification component 108 can determine the relevance 202 based upon predefined templates. In addition, the classification component 108 can intelligently determine the relevance based upon the relevance indicators 204-212 as well as based upon a variety of other information such as a profile of the mobile device 106 and/or the user of the mobile device 106. The profile can include transaction histories (e.g. purchases, travel, content sent/received), demographics, personal information, advertiser data, and so on. In particular, the classification component 108 can examine the entirety or a subset of the data available and can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g. naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

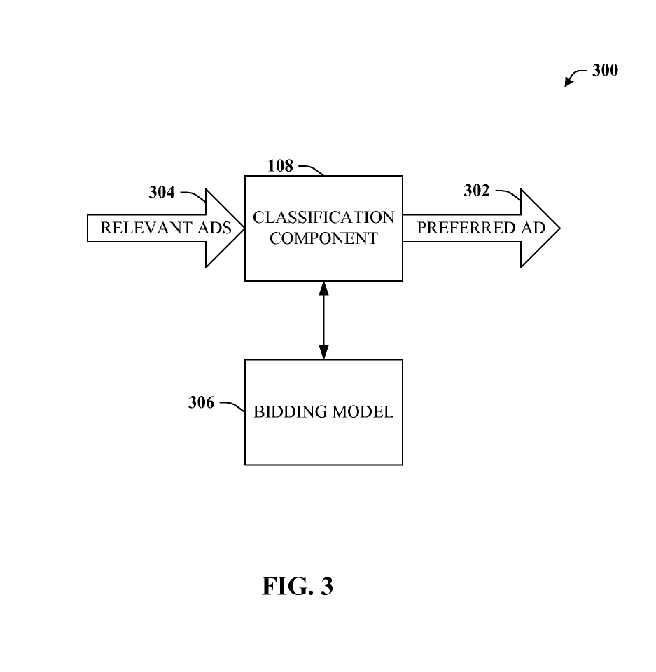

Turning now to FIG. 3, a system 300 that displays an ad based upon advertiser bidding is illustrated. The system 300 can include the classification component 108 that can organize ads based upon relevance as described supra. In addition, the classification component 108 can select a preferred ad 302 from a set of relevant ads 304 based upon a bidding model 306. It is to be appreciated that a number of advertisements may be deemed to be relevant ads 304, however, given a limited display surface and/or short duration, some relevant ads 304 may be selected (e.g., the preferred ad 302) for display over other relevant ads 304. The bidding model 306 can be based upon a highest bidder, a rotation scheme, an advertiser rating, branding, a quality ranking, as well as based upon the relevance indicators (e.g., relevance indicators 204-212 from FIG. 2) or a profile associated with a mobile device or user.

Thus, advertisers can potentially bid upon one or combinations of several of the relevance indicators. For example, a gas station may bid to display an ad to a mobile device within a certain area that is traveling at more than 35 miles per hour, a coffee shop may bid for mobile devices in the same area that are traveling at less than 5 miles per hour between the hours of 10:00 am and 2:00 pm, whereas an organic market may prefer to submit bids for mobile devices that have transactions histories associated with purchase of organic foods. It is to be appreciated that information associated with a mobile device or user need not be transmitted to the advertiser. Rather, the classification component 108 can select the preferred ad 302 without a necessity for sharing personal or private information with third parties, thus facilitating a privacy-centric manner of ad-targeting.

In another aspect, certain features of the profile or the relevance indicators can be shared to facilitate improved advertising content. For example, a mobile device 106 can supply a particular time frame or mode that indicates, e.g. that the next 4 hours will be spent shopping in the mall or that a user of the mobile device desires to buy a gift for 5 people. In return for sharing such information, the mobile device 106 may receive more relevant ads, optimized shopping routes, or advertisements indicating, e.g., that if all 5 gifts are purchased from the advertiser's outlet, then a suitable discount (e.g., 10% off) will be automatically applied.

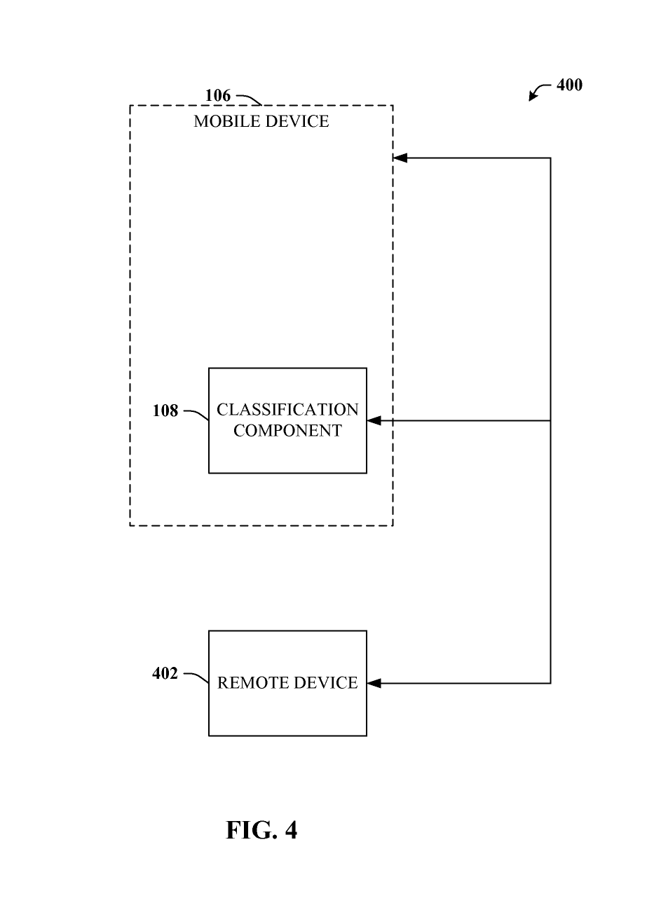

Referring now to FIG. 4, a system 400 that can display the advertisement to multiple devices is depicted. Generally, the system 400 can include the mobile device 106 as well as the classification component 108. The classification component 108 can display an advertisement (e.g., advertisement 104 or preferred ad 302) on the mobile device 106. In addition or in the alternative, the classification component 108 can transmit the advertisement to a remote device 402.

As one example, the remote device 402 can be a kiosk, sign, or billboard that, e.g., dynamically changes based upon inputs received. For instance, the billboard can be located in the example mall described supra, and wirelessly receive inputs from the mobile devices 106 within a given range. The inputs can include the advertisement selected by the classification component 108 as well as other information, such as portions of the profile associated with the mobile device 106. It is to be appreciated that the remote device 402 can aggregate inputs from numerous mobile devices 106 within range in order to determine what will be displayed at a given time.

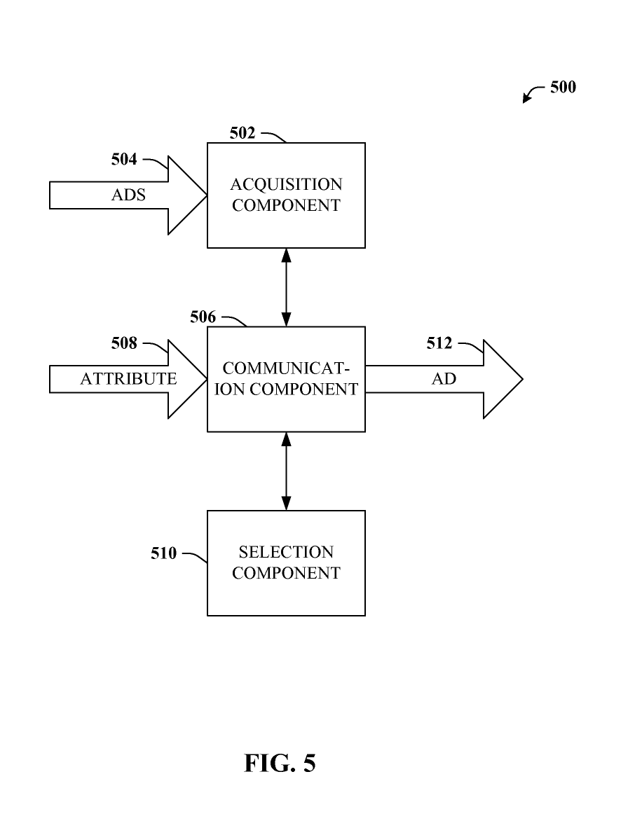

Referring now to FIG. 5, a system 500 that can facilitate tailored ad selection based upon attributes of a mobile device is illustrated. Generally, the system 500 can include an acquisition component 502 that can acquire a set of advertisements 504. The set of advertisements 504 is typically transmitted to the acquisition component from various advertisers that desire to have their respective ad(s) 504 placed in a relevant way. However, it is to be appreciated that the acquisition component 502 can acquire one or more of the set of advertisements 504 by various other means such as from an advertising data store (not shown) or the like.

In addition, the system 500 can include a communication component 506 that can receive an attribute 508 associated with a mobile device or a retailer or advertiser; and a selection component 510 that can select an advertisement 512 from the set advertisements 504 based at least in part upon the attribute 508. The attribute 508 can relate to a location, a velocity, an orientation, a path, a profile, etc. of the mobile device. In another aspect, the attribute can relate to an environment variable of the retailer or advertiser. Regardless, upon selection of the advertisement 512, the communication component 512 can transmit the advertisement 512. It is to be appreciated that the advertisement 512 can be transmitted to the mobile device as well as to other suitable display devices such as a billboard, kiosk, or similar device.

It is also to be appreciated that the selection component 510 can select the advertisement 512 in a manner similar to the classification component 108 of FIG. 1. In particular, the selection component 510 can employ all or portions of the relevance indicators 204-212 (which can be transmitted as attribute 508) discussed supra in order to determine or infer an appropriate advertisement 502. While the selection component 510 can be substantially similar to the classification component 108, some distinctions can exists. For example, the classification component 108 is typically housed in the mobile device which can facilitate transactions with advertisers in a more privacy-centric manner (e.g., demographics and/or profile information need not necessarily be shared in order to tailor or organize ads). In contrast, the selection component 510 is typically remote from the mobile device, but can facilitate other features such as aggregation of data relating to multiple mobile devices as well as data relating to a local environment or a particular store that a mobile device may not be suitable to obtain.

For example, in one aspect the advertisement 512 can be selected based upon a function of traffic in or around a certain store. Thus, if it is detected that a high number of shoppers patronizing a store fall into a particular demographic, then the selection component 510 can select an ad 512 directed to that demographic, wherein the communication component 506 can transmit the ad 512 to a remote device such as a storefront ad billboard or a controller for announcing sales over loudspeakers or intercoms.

As another example, if it is detected that a particular mobile device has been in the children's depart of a store for several minutes, then the selection component 510 can select an advertisement 512 that relates to products or services in that department, and the communication component 506 can transmit the advertisement 512 to the mobile device. Moreover, in the event that the mobile device includes a suitable scanner or reader, scanning the bar code of a shirt that is normally $29.99 can prompt an advertisement 512 that reduces the shirt to $19.99 based upon a loyalty card membership associated with the mobile device, an overstock condition, or some other factor.

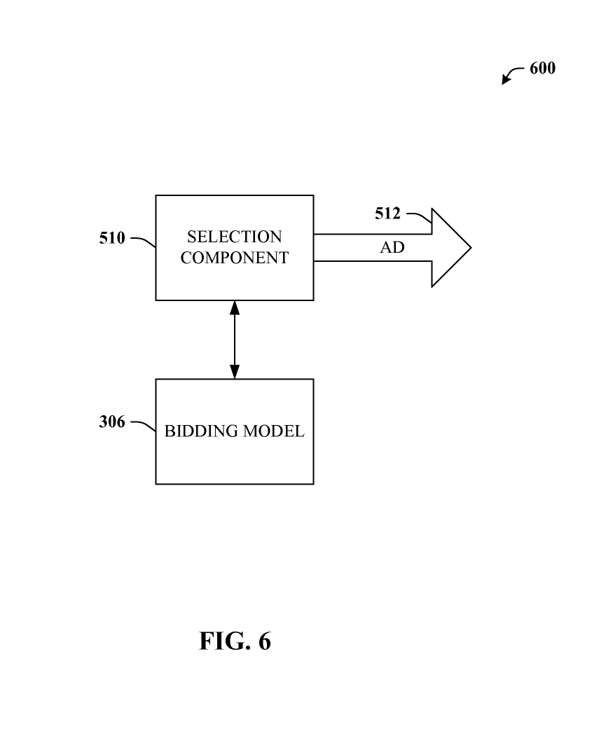

Turning now to FIG. 6, a system 600 that can utilize a bidding model for ad selection is illustrated. In general, the system 600 can include the selection component 510 that can select the advertisement 512 based at least in part upon one or more attributes. In addition, the selection component 510 can further employ the bidding model 306 in order to select the advertisement 512. In addition to the examples provided supra in connection with the bidding model 306, the bidding model 306 can also allow advertisers to bid upon environment variables as well as relevance indicators.

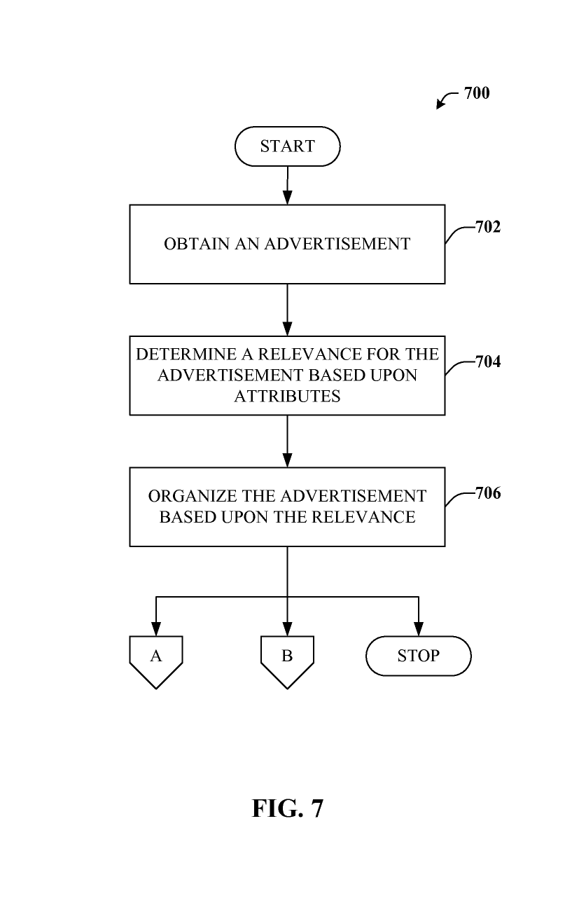

FIGS. 7, 8, and 9 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 7, an exemplary method 700 for facilitating enhanced content organization for a mobile device is illustrated. Generally, at reference numeral 702, an advertisement can be obtained. It is to be appreciated that the advertisement can be a mobile advertisement such as an advertisement that is specifically targeted or designed for display on a mobile device, or an advertisement that is issued based upon a location, velocity, or path or trajectory of the mobile device. It is also to be appreciated that the advertisement can be received by a mobile device from an advertiser or retailer or in other cases the advertisement can be received by the mobile device from a data store.

At reference numeral 704, a relevance for the advertisement can be determined based upon attributes associated with a mobile device. Next, at reference numeral 706 the advertisement can be organized or sorted based upon the relevance determined at reference numeral 704. Thus, the method 700 can collect suitable advertisements from a variety of source, determine or infer a relevance of the advertisement based upon a number of attributes associated with a mobile device as described herein, and can arrange or filter the advertisements.

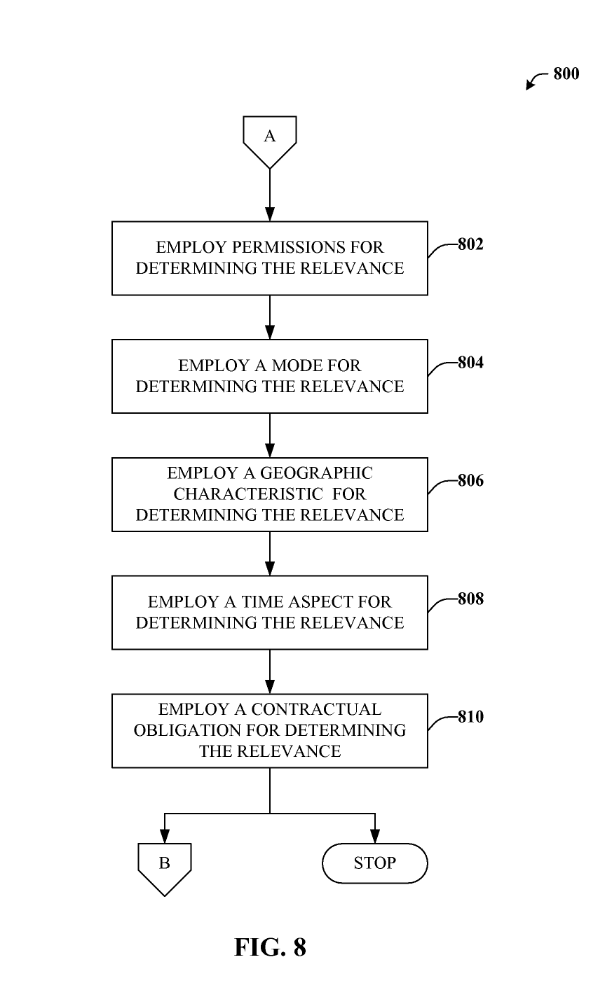

With reference now FIG. 8, an exemplary method 800 for determining a relevance is provided. At reference numeral 802, permissions associated with the mobile device can be employed for determining the relevance. For example, preferences can be set to indicate that advertisements or certain types of advertisements are not appropriate or relevant unless certain thresholds, qualifications, or conditions are met. Thus, the advertisement can be filtered or removed unless the advertisement pertains to a particular product, service, vendor, advertiser, and so forth. Similarly, the permissions can indicate that advertisements should be filtered unless the advertisement provides a particular type of incentive such as a discount over a certain percentage, a free trial, helpful data or information, and so on.

At reference numeral 804, a mode associated with a mobile device or a user of the mobile device can be employed for determining the relevance. For example, the mobile device or user thereof can be in a browsing mode in which many types of advertisements may be relevant, or in a purchase mode, where it is known exactly what will be purchases and/or where the product or service is located so it is conceivable that no advertisements are appropriate. In addition, the mode can be based upon an ordering of events or transactions such that the advertisement may only be relevant before or after a certain event or transaction. Furthermore, the mode may relate to a condition of the mobile device or user, such as, e.g., based upon detection of a low battery charge level or a physical condition associated with the user.

At reference numeral 806, geographic characteristics can be employed for determining the relevance. Suitable geographic characteristics can include a position or location of the mobile device, a velocity (e.g. speed and direction) of the mobile device, or a past route or project path of the mobile device.

At reference numeral 808, a time aspect can be employed for determining the relevance. For example, the advertisement may be more relevant if utilized at some time other than when they are received and/or obtained. As such, a snooze feature can be employed in connection with determining the relevance. It is to be appreciated that the snooze feature can be based upon inferences as well as input from a user of mobile device. In either case, display or some other further use of the advertisement can be delayed for a certain amount of time or until one or more conditions are satisfied.

At reference numeral 810, a contractual obligation can be employed for determining the relevance. For example, the mobile device 106 or service fees related thereto can be provided free of charge or an associated cost can be subsidized in exchange for rights or guarantees to deliver or display the advertisement 104 to the mobile device 106. Such contractual obligations can also affect the relevance of the advertisement.

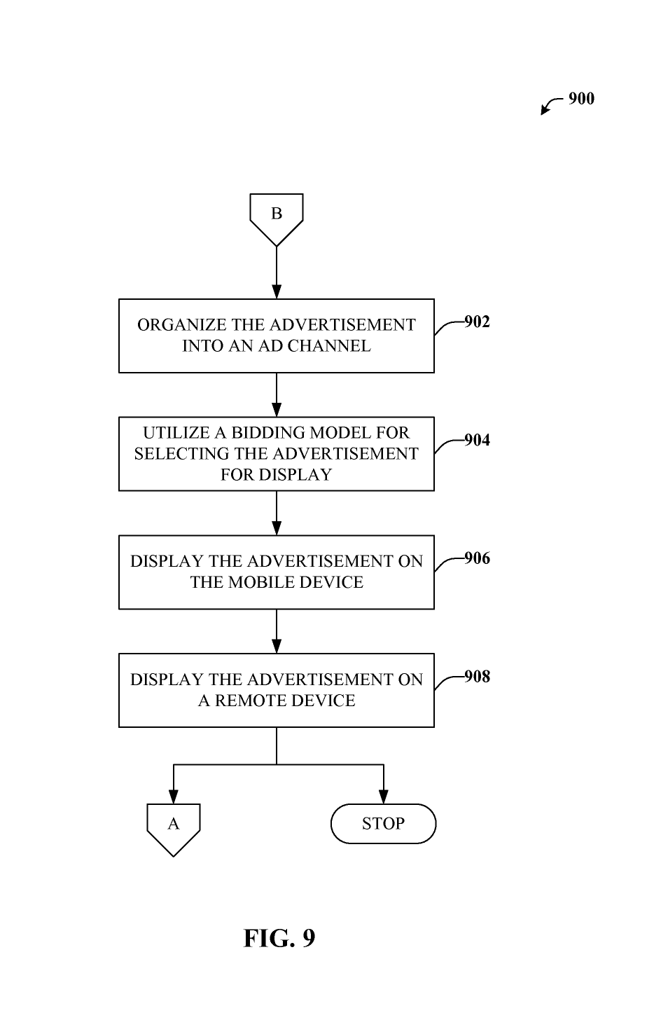

Turning briefly to FIG. 9, an exemplary method 900 for providing additional features associated with ad organization is depicted. At reference numeral 902, the advertisement can be organized into an ad channel. For example, the ad channel can provide a clear division between advertisements and other content such as friends, family, or other contacts as well as from text or multimedia messages from contacts. At reference numeral 904, a bidding model can be utilized for selecting the advertisement(s) to display.

It is to be appreciated that a number of advertisements may be deemed to be relevant, however, given a limited display surface and/or short duration, some relevant advertisements may be selected for display over other relevant advertisements. The bidding model can be based upon a highest bidder, a rotation scheme, an advertiser rating, branding, a quality ranking, as well as based upon the relevance-determining factors such as those described in connection with reference numerals 802-810 of FIG. 8. At reference numeral 906, the selected advertisement can be displayed to the mobile device. Yet according to another aspect, at reference numeral 908, the selected advertisement can be displayed to a remote device such as a sign, billboard, terminal, or kiosk in proximity to the mobile device.

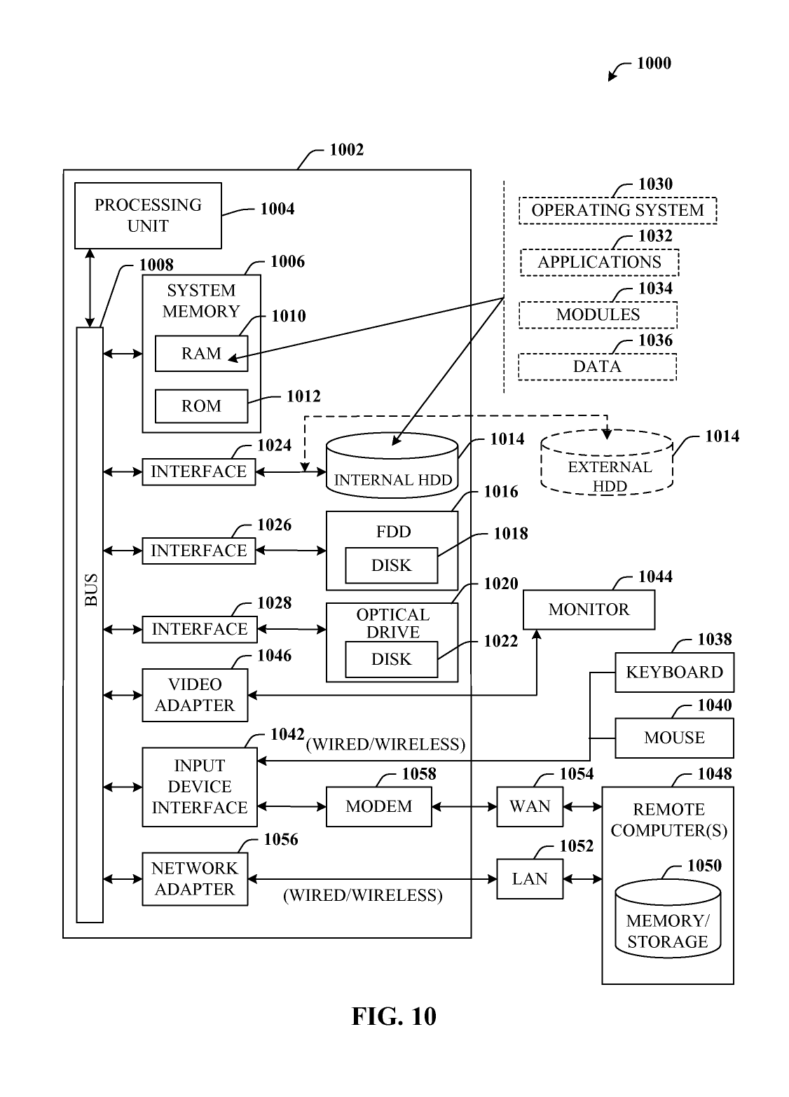

Referring now to FIG. 10, there is illustrated a block diagram of an exemplary computer system operable to execute the disclosed architecture. In order to provide additional context for various aspects of the claimed subject matter, FIG. 10 and the following discussion are intended to provide a brief, general description of a suitable computing environment 1000 in which the various aspects of the claimed subject matter can be implemented. Additionally, while the claimed subject matter described above may be suitable for application in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects of the claimed subject matter includes a computer 1002, the computer 1002 including a processing unit 1004, a system memory 1006 and a system bus 1008. The system bus 1008 couples to system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the claimed subject matter can be implemented with various commercially available operating systems or combinations of operating systems.

A user can enter commands and information into the computer 1002 through one or more wired/wireless input devices, e.g. a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g. a wide area network (WAN) 1054. Such LAN and WAN networking environments are commonplace in offices and companies, and facilitate enterprise-wide computer networks, such as intranets, all of which may connect to a global communications network, e.g. the Internet.

When used in a LAN networking environment, the computer 1002 is connected to the local network 1052 through a wired and/or wireless communication network interface or adapter 1056. The adapter 1056 may facilitate wired or wireless communication to the LAN 1052, which may also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

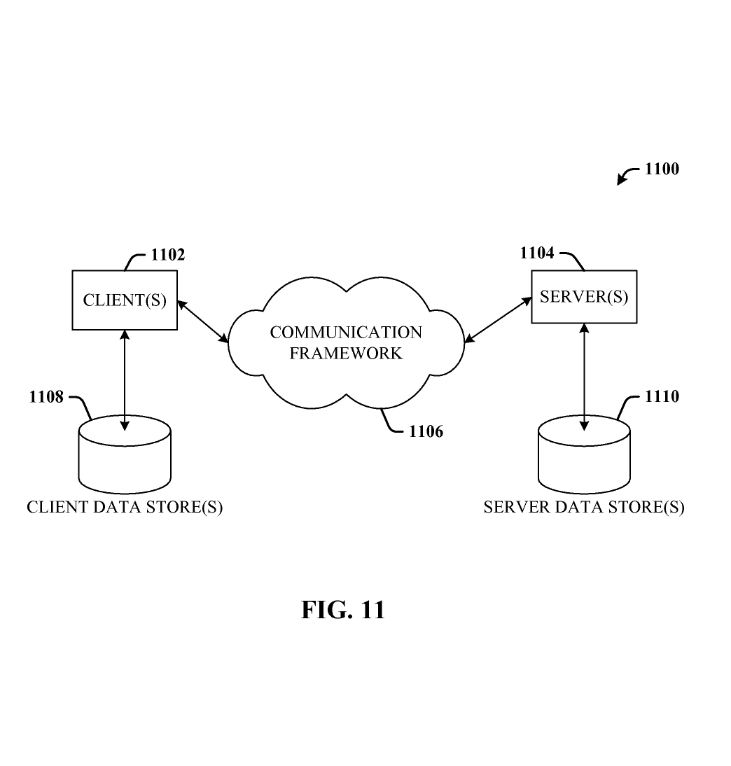

Referring now to FIG. 11, there is illustrated a schematic block diagram of an exemplary computer compilation system operable to execute the disclosed architecture. The system 1100 includes one or more client(s) 1102. The client(s) 1102 can be hardware and/or software (e.g., threads, processes, computing devices). The client(s) 1102 can house cookie(s) and/or associated contextual information by employing the claimed subject matter, for example.

The system 1100 also includes one or more server(s) 1104. The server(s) 1104 can also be hardware and/or software (e.g., threads, processes, computing devices). The servers 1104 can house threads to perform transformations by employing the claimed subject matter, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates enhanced content organization for a mobile device, comprising:
a receiving component that obtains an advertisement delivered to a mobile device; and
a classification component that organizes the advertisement based at least in part upon a relevance of the advertisement.

2. The system of claim 1, the advertisement is a mobile advertisement.

3. The system of claim 1, the classification component determines the relevance based upon contractual obligations associated with the mobile device.

4. The system of claim 1, the classification component determines the relevance based upon permissions associated with the mobile device.

5. The system of claim 1, the classification component determines the relevance based upon a mode associated with the mobile device.

6. The system of claim 1, the classification component determines the relevance based upon geographic characteristics associated with the mobile device.

7. The system of claim 1, the classification component determines the relevance based upon a time in which the content is received.

8. The system of claim 1, the classification component determines an appropriate time to display the advertisement based upon relevance indicators.

9. The system of claim 1, the classification component organizes the advertisement into an ad channel.

10. The system of claim 1, the classification component selects for display a preferred advertisement from a set of relevant advertisements based upon a bidding model.

11. The system of claim 1, the classification component displays the advertisement on the mobile device and/or transmits the advertisement for display on a disparate device.

12. A system that facilitates tailored ad selection based upon attributes of a mobile device, comprising:
an acquisition component that acquires a set of advertisements;
a communication component that receives an attribute and transmits an advertisement from the set of advertisements; and
a selection component that selects the advertisement based at least in part upon the attribute.

13. The system of claim 12, the attribute is associated with a mobile device and pertains to at least one of a location, a velocity, an orientation, a path, or a profile.

14. The system of claim 12, the attribute pertains to an environment variable associated with a retailer or advertiser.

15. The system of claim 12, the selection component selects the advertisement further based upon a bidding model.

16. A method for facilitating enhanced content organization for a mobile device, comprising:
obtaining an advertisement;
determining a relevance for the advertisement based upon attributes associated with a mobile device; and
organizing the advertisement based upon the relevance.

17. The method of claim 16, the advertisement is mobile advertisement.

18. The method of claim 16, the advertisement is received by and obtained from a mobile device.

19. The method of claim 16, further comprising at least one of the following acts:
employing permissions for determining the relevance;
employing a mode for determining the relevance;
employing a geographic characteristic for determining the relevance;
employing a time aspect for determining the relevance; or
employing a contractual obligation for determining the relevance.

20. The method of claim 16, further comprising at least one of the following acts:
organizing the advertisement into an ad channel;
utilizing a bidding model for selecting the advertisement for display;
displaying the advertisement on the mobile device; or
displaying the advertisement on a remote device.
